(19) United States
(12) Patent Application Publication
(10) Pub. No.: US 2024/0403675 A1
(43) Pub. Date: Dec. 5, 2024

(54) DISTRIBUTED STOCHASTIC TECHNIQUES FOR MAINTAINING A NOMINAL ALTERNATING CURRENT FREQUENCY IN AN ALTERNATING CURRENT ELECTRICAL POWER GRID

(71) Applicant: University of Central Florida Research Foundation, Inc., Orlando, FL (US)

(72) Inventors: Guanyu Tian, Oviedo, FL (US); Qun Zhou Sun, Oviedo, FL (US)

(73) Assignee: University of Central Florida Research Foundation, Inc., Orlando, FL (US)

(21) Appl. No.: 18/638,341

(22) Filed: Apr. 17, 2024

Related U.S. Application Data
(60) Provisional application No. 63/504,964, filed on May 30, 2023.

(51) Int. Cl. G06N 7/01; G06F 7/58

(52) U.S. Cl. CPC G06N 7/01; G06F 7/58

(57) ABSTRACT

Techniques for stochastic control of at least one load is provided. Electric power generators provide alternating current (AC) to a plurality of consumer premises (CP). Each CP has one or more loads configured to be electrically powered by the AC. The stochastic control is performed at each consumer premises in a distributed manner. The stochastic control is used to maintain or increase the frequency of the AC provided by an AC electrical power distribution grid when such AC frequency falls below a nominal AC frequency of the AC electrical power distribution grid.

### CROSS-REFERENCE TO RELATED APPLICATIONS

The present application claims benefit of U.S. Patent Application Ser. No. 63/504,964 filed May 30, 2023; the entire contents of the aforementioned patent application are incorporated herein by reference as if set forth in their entirety.

### U.S. GOVERNMENT LICENSE RIGHTS

This invention was made with Government support under Award No. DE-EE0009152 awarded by the U.S. Department of Energy. The Government has certain rights in the invention.

### BACKGROUND

An alternating current (AC) provided through an AC electrical power grid has a nominal frequency rating, e.g., 50 Hz or 60 Hz. Varying power consumption by loads drawing the AC from the AC electrical power grid causes the frequency of the AC to vary from the nominal value. Most commonly, too many loads are drawing too much power from the AC electrical grid and causing the AC frequency (generated by AC power sources) to decrease below the nominal value.

It is undesirable when the AC frequency deviates from its nominal value. A turbine generator (which provides AC electrical power), e.g., blades thereof, may be damaged when the AC frequency diverges from the nominal frequency rating for an extended time period. Also, a load, drawing AC, may malfunction due to varying AC frequency. For example, when the load is a motor, the motor's speed may change proportionally with the AC frequency, and may operate out of specification due to the varying AC frequency.

To balance power generation and load power demand, a power utility has two choices. Firstly, the power utility can turn on more AC power source(s). This is more costly due to both capital costs and operating expenses for respectively constructing and operating such additional power source(s).

To avoid such costs, secondly, a power utility's control center is communicatively coupled to at least a subset of loads configured to draw AC from the power utility's AC electrical power grid. When AC electrical power is drawn by loads through the AC electrical power grid exceeds the amount of AC electrical power produced by active AC power sources, the control center commands, for a finite period of time, some or all of the at least a subset of loads to reduce AC electrical power consumption, e.g., to turn off. By restoring the balance between AC power generation and load demand, the AC frequency is restored to its nominal value.

Although less than the cost of building and operating new AC power source(s), implementing this technique of disabling loads is undesirably expensive. A control center, a communications system communicatively coupling the control center and loads, and equipment at consumer premises to regulate provision of AC electrical power to the load(s), in the consumer premises, responsive to communications from the control center are required to facilitate such control. Further, this technique of disabling loads may also be subject to failures of the communications system, e.g., due to damage from weather or other conditions.

### SUMMARY

In some aspects, the techniques described herein relate to a method for stochastically determining whether to reduce alternating current (AC) provided to a load, including: receiving a frequency of the AC; receiving or generating a random number; determining a probability threshold or a function of the probability threshold, wherein the probability threshold is a function of a difference between the frequency of the AC and a nominal frequency rating of an AC electrical power grid configured to provide AC to the load; determining whether (a) the frequency of the AC is less than the nominal frequency rating and (b) the random number is less than respectively the probability threshold or the function of the probability threshold; and determining that (a) the frequency of the AC is less than the nominal frequency rating and (b) the random number is less than respectively the probability threshold or the function of the probability threshold, then transmitting an AC reduction signal configured to cause the AC drawn by the load to be reduced for a first time period.

In some aspects, the techniques described herein relate to a non-transitory computer readable medium storing a program causing at least one processor to execute a process to stochastically determine whether to reduce alternating current (AC) provided to a load, the process including: receiving a frequency of the AC; receiving or generating a random number; determining a probability threshold or a function of the probability threshold, wherein the probability threshold is a function of a difference between the frequency of the AC and a nominal frequency rating of an AC electrical power grid configured to provide AC to the load; determining whether (a) the frequency of the AC is less than the nominal frequency rating and (b) the random number is less than respectively the probability threshold or the function of the probability threshold; and determining that (a) the frequency of the AC is less than the nominal frequency rating and (b) the random number is less than respectively the probability threshold or the function of the probability threshold, then transmitting an AC reduction signal configured to cause the AC drawn by the load to be reduced for a first time period.

In some aspects, the techniques described herein relate to an apparatus which stochastically determines whether to reduce alternating current (AC) provided to a load, the apparatus including: communications circuitry configured to receive a frequency of the AC; and processing circuitry, communicatively coupled to the communications circuitry, and configured to perform a process including: receiving the frequency of the AC; receiving or generating a random number; determining a probability threshold or a function of the probability threshold, wherein the probability threshold is a function of a difference between the frequency of the AC and a nominal frequency rating of an AC electrical power grid configured to provide the AC to the load; determining whether (a) the frequency of the AC is less than the nominal frequency rating and (b) the random number is less than respectively the probability threshold or the function of the probability threshold; and determining that (a) the frequency of the AC is less than the nominal frequency rating and (b) the random number is less than respectively the probability threshold or the function of the probability threshold, then causing the communications circuitry to transmit an AC reduction signal configured to cause the AC drawn by the load to be reduced for a first time period.

### BRIEF DESCRIPTION OF THE DRAWINGS

Embodiments of the present invention can be more easily understood and further advantages and uses thereof more readily apparent, when considered in view of the description of the preferred embodiments and the following figures in which:

FIG. 1A illustrates one embodiment of a stochastic control system configured to stochastically control provision of AC electrical power to a load;

FIG. 1B illustrates a block diagram of Z consumer premises each of which includes a stochastic controlled load(s) which consumes AC, e.g., power, from the AC power source(s); and

FIG. 2 illustrates a flow diagram of one embodiment of a method of performing one instance of stochastically determining whether to reduce AC provided to at least one load.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

Techniques are employed at consumer premises to stochastically control provision of AC electrical power to one or more loads in the consumer premises. Exemplary loads are illustrated elsewhere herein. One or more loads in each consumer premises are subject to being randomly turned off for a period of time. The period of time is subject to how long it takes to return the AC frequency to return to the nominal frequency. Embodiments of the invention do not require the communications system to facilitate disablement of loads, and thus avoid the cost and reliability concerns arising from the use of communications system. Thus, embodiments of the invention provide an improvement over conventional techniques described above used to avoid disruption and/or damage to electrical power generator(s) and loads drawing electrical power from such electrical power generator(s). Such techniques may be used by power utilities, energy aggregators, appliance manufacturers, and/or building construction companies.

The aggregate of such stochastic control of provision of AC electrical power to such load(s) at a multitude of consumer premises ensures that the frequency of the AC electrical power provided through an AC electrical power grid does not exceed a nominal frequency for an extended period of time that would cause damage or malfunction to sources of the AC electrical power or the load(s) consuming the AC electrical power. As long as there are sufficient consumer premises whose one or more loads have their AC, e.g., power, consumption¹ stochastically controlled, then the AC frequency returns to the nominal frequency when the one or more loads, in an initial set of consumer premises, have their AC, e.g., power, consumption diminished, e.g., reduced to zero. ¹ AC power consumption is a function of AC consumption.

In comparison to the technique utilizing a control center communicatively coupled to consumer premises to affect AC, e.g., power, reduction at the consumer premises, embodiments of the invention:
(a) more fairly distribute AC, e.g., power, reduction amongst an aggregate of consumer premises;
(b) more promptly, e.g., within or less than 2 seconds, cause the AC frequency to return to the nominal AC frequency;
(c) thus, have a diminished affect at each consumer premise subject to AC, e.g., power, reduction. For example, water temperature or building temperature is not disturbed by such a prompt reduction of AC, e.g., power;
(d) has an exponentially diminished probability of time sequential reductions at a consumer premises because the probability of a time sequential AC, e.g., power, reduction is a function of α^{N}, where N is a number of AC reductions during a second time period (e.g., a number of reductions in sequential time periods), and α is a probability threshold; and
(e) significantly diminished communication requirements and corresponding cost because no central control is required to reduce power consumption at consumer premises.

Embodiments of the invention may optionally include component(s) configured to communicate to the power utility that a stochastic control system is enabled in consumer premises. As a result, the power utility can optionally (a) determine whether enough loads are controlled by the stochastic control system so as to ensure that deviations from nominal frequency can be corrected, and (b) confirm stochastic controller usage on a consumer premise by consumer premise basis to award financial renumeration to those consumer premises' utilizing embodiments of the invention.

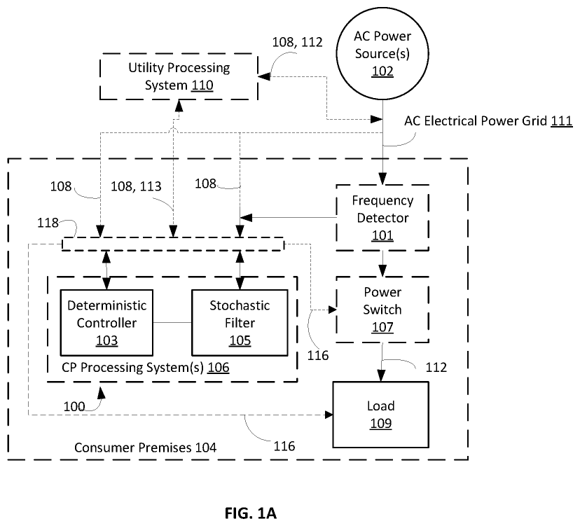

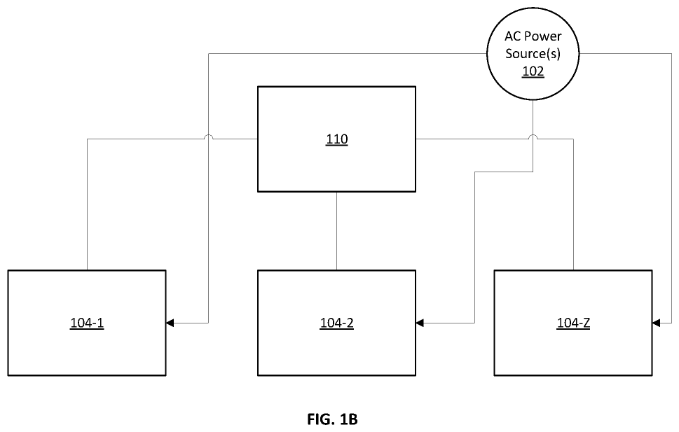

FIG. 1A illustrates one embodiment of a stochastic control system 100 configured to stochastically control provision of AC electrical power to a load. The stochastic control system 100 includes a deterministic controller (or deterministic controller circuitry) 103, a stochastic filter (or stochastic filter circuitry) 105. Optionally, the deterministic controller 103 and the stochastic filter 105 are stored and executed in one or more consumer premises (CP) processing system(s) (or processing circuit(s) or processing circuitry) 106; each processing circuit may comprise state machine(s) and/or neural network(s). Optionally, the stochastic control system 100 also includes an optional communications circuitry 118, an optional frequency detector (or frequency detector circuitry) 101 and/or an optional power switch 107; alternatively, each of communications circuitry 118, the frequency detector 101 and the power switch 107 may be external to the stochastic control system 100 or not used.

Optionally, the CP processing system(s) 106 (e.g., the deterministic controller 103 and the stochastic filter 105) and the communications circuitry 118 are co-packaged with the load 109. Optionally, the optional frequency detector 101 and/or the power switch 107 are also co-packaged with the load 109.

The optional communications circuitry 118 is configured to facilitate provision of data (a) to the stochastic control system 100, e.g., the deterministic controller 103 and/or the stochastic filter 105, from external sources, e.g., the optional frequency detector 101, (b) from the stochastic control system 100, e.g., the stochastic filter 105 to the optional power switch 107 or alternatively directly to the load 109, and/or (c) from the stochastic control system 100 to the power utility, e.g., to confirm that a consumer premises 104 is utilizing the stochastic control system 100². Optionally, data provided to or from the stochastic control system 100, e.g., the deterministic controller 103 and the stochastic filter 105, is communicated through the communications circuitry 118. The communications circuitry 118 may include data bus (ses), wireless receiver(s), wireless transmitter(s), wireless transceiver(s), wired receiver(s), wired transmitter(s), and/or wired transceiver(s). ² Optionally, the confirmation that a consumer premises 104 is utilizing the stochastic control system 100 may be used to provide a financial credit to the consumer premises 104 for doing so. Optionally, communications between the utility providing AC power through the AC power source(s) 102, e.g., the utility processing system 110, and the stochastic control system 100, e.g., the optional communications circuitry 118, may be made wirelessly through a wireless AC electrical power meter for the consumer premises 104; such meter may be configured to wirelessly relay the confirmation to the power utility, e.g., the utility processing system 110, that the consumer premises 104 has stochastic control of a load 109 enabled. In the alternative to providing confirmation from the consumer premises 104 to the power utility, the power utility can identify fourth time periods when the AC frequency of AC distributed by the AC electrical power grid 111 falls below the nominal AC frequency, and use meter data to identify consumer premises which have, during such fourth time periods, a drop in AC drawn, e.g., over the first time period.

The data from the stochastic control system 100, e.g., the stochastic filter 105, provided to the optional power switch and/or the load 109 may be a control signal (or AC reduction signal) 116 indicating AC provided to the load 109 should be reduced, e.g., to zero, for a first period of time, e.g., 2 seconds or less. Optionally, the control signal 116 is provided from the stochastic filter 105 and/or the CP processing system(s) 106 through the communications circuitry 118 to the power switch 107 and/or the load 109. Upon receiving the control signal 116, the power switch 107 and/or the load 109 is configured to respectively provide, for a first time period, reduced, e.g., to zero, AC, e.g., AC power, to the load 109 or consume less, e.g., zero, AC, e.g., AC power.

For pedagogical reasons, the stochastic control system 100 is illustrated as stochastically controlling provision of AC electrical power to a single load 109 at the consumer premises; however, more than one load at the consumer premises may be controlled stochastically. The AC electrical power is generated by one or more AC power source(s) (AC power source(s)) 102 and delivered from the AC power source(s) 102 through an AC electrical power grid 111 to the load 109, e.g., in consumer premises 104. Non-limiting examples of a load 109 include an appliance (for example, a hot water heater, an air conditioner or heat pump, a refrigerator, a freezer, a washing machine, or a dryer), an electric vehicle, and a battery storage system (e.g., for a structure for example a house), however, a load 109 may be any other electrical equipment used in consumer premises 104.

For pedagogical purposes, the deterministic controller 103 and the stochastic filter 105 (i.e., the CP processing system(s) 106 including the deterministic controller 103 and the stochastic filter 105), the optional frequency detector 101, the optional communications circuitry 118, and the optional power switch 107 are illustrated as being located outside of the load 109. Alternatively, one or more of these components, e.g., such as the CP processing system(s) 106 including the deterministic controller 103 and the stochastic filter 105, may be incorporated into the load 109.

Each of the deterministic controller 103 and stochastic filter 105, e.g., the CP processing system(s) 106, are configured to receive, e.g., through the optional communications circuitry 118, an AC frequency 108 of the AC electrical power 112 generated from the AC power source(s) 102 and provided through the AC electrical power grid 111 to the load 109. Optionally, the deterministic controller 103 and stochastic filter 105, e.g., the CP processing system(s) 106, are configured to provide a stochastic control system enable signal 113 indicating to a utility processing system (or utility processing circuitry) 110 (e.g., of the electrical power utility supplying AC power to the consumer premises) that the consumer premises 104 is utilizing a stochastic control system 100 to control provision of AC to the load 109. Optionally, the stochastic control system enable signal 113 is transmitted through the optional communications circuitry 118, e.g., through the AC electrical power grid 111 or by any other communications means including wireless broadcast, e.g., using cellular communications.

The AC frequency 108 may be measured remotely from the load 109 and provided to the deterministic controller 103 and the stochastic filter, e.g., the CP processing system(s) 106, optionally through the AC electrical power grid 111 or by any other communications means including wireless broadcast, e.g., using cellular communications; optionally, the optional communications circuitry 118 is configured to receive such data. Optionally, the utility processing system 110 is configured to transmit the AC frequency 108 through the AC electrical power grid 111 or by other communications means, e.g., to the optional communications circuitry 118.

Alternatively, a frequency detector (or frequency detector circuitry) 101 may be located in or by the consumer premises 104 where the load 109 is located. The frequency detector 101 is configured to measure the frequency of the AC electrical power delivered by the AC electrical power grid.

During a third time period, the stochastic control system 100, e.g., the deterministic controller 103 and/or the CP processing system(s) 106, is configured to determine whether or not the AC frequency is less than a nominal frequency rating of the AC electrical power grid 111, e.g., 50 Hz or 60 Hz. Optionally, the deterministic controller 103 communicates such results to the stochastic filter 105. During the third time period, the stochastic control system 100, e.g., the stochastic filter 105 and/or the CP processing system(s) 106, is configured to determine whether or not a randomly generated number (i.e., random number ξ) is greater than a probability threshold a.

For the third time period, the stochastic control system 100, e.g., the stochastic filter 105, is configured to determine whether the AC frequency is less than the nominal frequency rating of the AC electrical power grid 111 and whether the random number is less than the probability threshold α or a function of the probability threshold α. To do so, the stochastic control system 100, e.g., the stochastic filter 105 and/or the CP processing system(s) 106, is configured to generate the random number ξ from a source of uniform random numbers or a source of non-uniform random numbers, e.g., a Gaussian distribution. Optionally, the random number ξ may be generated by a true random number generator or a pseudorandom number generator. The stochastic control system 100, e.g., the stochastic filter 105 and/or the CP processing system(s) 106, is also configured to generate the probability threshold α. The random number ξ is compared against a probability threshold α (or a function of the probability threshold α). The probability threshold is a function of, e.g., an absolute value of, a difference between the received or the measured frequency of the AC, e.g. power, and a nominal frequency rating of an AC, e.g., power provided by the AC electrical power grid 111 configured to provide AC, e.g., power to one or more loads. Optionally, the probability threshold is specified by:

$$α = k * \vert ω - {ω}_{o} \vert ,$$

where k is a scalar value, has a value greater than zero, and is a constant or is a function of other parameters, ω is a measured or received frequency of the AC, e.g., electrical power, received by the load 109, and ω₀ is a nominal frequency rating of the AC electrical power grid 111. Optionally, k has a constant value or has a value which varies based on other parameters. Optionally, k may be derived from a function as discussed elsewhere herein. The probability threshold, α, is a function of, e.g., the absolute value of the difference between the received or measured frequency of the AC electrical power and the nominal frequency rating of the AC electrical power grid 111; by making the probability threshold α dependent on such a difference, the risk that embodiments of the invention will diminish power to load(s) in too many consumer premises at the same time and cause the frequency of the AC electrical power in the AC electrical power grid 111 to drop below the nominal frequency rating ω₀. Optionally, the probability threshold α is a number that is greater than or equal to zero and less than or equal to one.

Optionally, k equals 0.1. Optionally, the scalar value of k and/or the probability threshold α may be a function of one or more parameters, e.g., related to the type of load being power by the AC or another factor.³ Such other parameters may include at least one of: temperature, differential temperature, state of charge, current electricity price. ³ Optionally, the probability threshold α (or a result of the function thereof) is within a first numerical range and the random number is within a second numerical range of numbers. Optionally, the first and the second numerical ranges are identical.

Optionally, one such variable is a temperature or a differential temperature. For example, a load being stochastically controlled is a water heater, the constant k may be proportional to the water temperature of the water heater; thus, as the water temperature increases, the likelihood that the water heater will be provided diminished AC, e.g., zero AC, increases. For example, a load being stochastically controlled is an air conditioner or a heat pump, the constant k may be inversely proportional to a magnitude of a difference between an indoor temperature (e.g., air temperature in a structure such as an office building or house) and an outdoor temperature (e.g., air temperature outside of the structure); thus, as the magnitude of such difference decreases, the likelihood that the air conditioner or heat pump will be provided diminished AC, e.g., zero, increases. Optionally, each of the above described temperatures may be provided to the stochastic control system 100, the stochastic filter 105 and/or the CP processing system(s) 106.

Optionally, one such a variable is a number of times N that the stochastic control system 100 caused a reduction of AC, at one or more loads at the consumer premises 104, during a second time period, e.g., a number of reductions in sequential time periods. For example, the probability threshold α may be raised to a power of an argument N, α^{N}, where N is a number of AC reductions during a second time period (e.g., a number of time sequential reductions), and a is the probability threshold. Optionally, the second time period is greater than the first time period.

If the AC frequency is less than to the nominal frequency rating of the AC electrical power grid 111 and if the random number is less than the probability threshold α or a function of the probability threshold α, then the stochastic control system 100, e.g., the CP processing system(s) 106, the stochastic filter 105, and/or the optional communications circuitry 118, is configured to transmit the control signal 116 configured to cause one or more loads in a consumer premises 104 to reduce, for a first time period, AC, e.g., power, consumption, e.g., to zero. Optionally, the first time period is 2 seconds or less. After the first time period, repeat the process starting with receiving or measuring the AC frequency, receiving the random number, and/or generating the probability threshold.

FIG. 1B illustrates a block diagram of Z consumer premises 104-1, 104-2, 104-Z each of which includes a stochastic controlled load(s) which consumes AC, e.g., power, from the AC power source(s) 102. Optionally, such stochastic control is provided in a manner described elsewhere herein. Z is an integer greater than zero, and optionally may be in the thousands, tens of thousands, hundreds of thousands, or million.

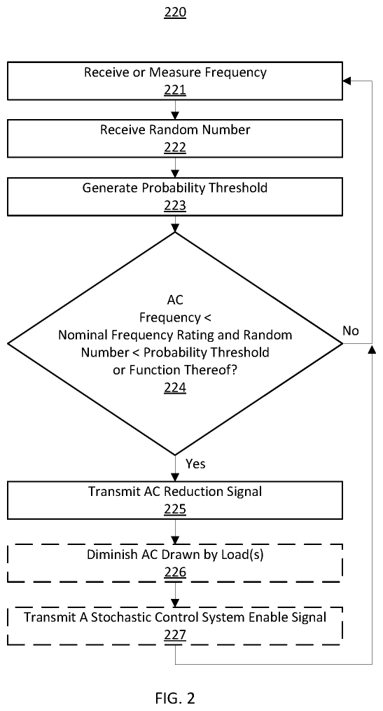

FIG. 2 illustrates a flow diagram of one embodiment of a method 220 of performing one instance of stochastically determining whether to reduce AC provided to at least one load. Optionally, method 220 may be implemented using the stochastic control system 100 of FIG. 1A and/or component(s) thereof; however, other system implementations may be used in the alternative including without limitation using one or more portions of the stochastic control system 100 of FIG. 1A.

The blocks of the flow diagram have been arranged in a generally sequential manner for case of explanation; however, it is to be understood that this arrangement is merely exemplary, and it should be recognized that the processing associated with the methods (and the blocks shown in the Figures) can occur in a different order (for example, where at least some of the processing associated with the blocks is performed in parallel and/or in an event-driven manner).

In block 221, a frequency of AC is received. Optionally, the received frequency of the AC is measured, e.g., in the consumer premises in which the load is located. In block 222 a random number ξ is received or generated, e.g., from a uniform or non-uniform random number generator as discussed elsewhere herein; optionally, the random number is generated prior to being received.

In block 223, a probability threshold α, or a function of the probability threshold α, is generated. The probability threshold α is a function, e.g., of an absolute value, of a difference between the received or the measured frequency of the AC, e.g., power, and a nominal frequency rating of an AC, e.g., power provided by the AC electrical power grid the load(s), and is described in more detail elsewhere herein.

In block 224, whether (a) the AC frequency is less than the nominal frequency rating and (b) the random number ξ is less than the probability threshold α (or the function of the probability threshold α) is determined. A function of the probability threshold α, e.g., an exponential function of the probability threshold α, is discussed elsewhere herein. If (a) the AC frequency is not less than the nominal frequency rating of an electrical power distribution system (configured to provide AC electrical power to the load(s) or (b) the random number ξ is not less than the probability threshold α (or the function of the probability threshold α), then after a first time period proceed to block 221.

If (a) the AC frequency is less than the nominal frequency and (b) the random number ξ is less than the probability threshold α (or the function of the probability threshold α), then in block 225 transmit a control signal (or AC reduction signal) configured to cause the AC, e.g., power, drawn by the load(s) to be reduced, for the first time period, e.g., to zero or a non-zero level. Optionally, the first time period is two seconds or less.

Optionally, in block 226, the AC, e.g., power, drawn by, e.g., provided by, the load(s) is diminished, e.g., reduced to zero. Optionally, in block 227, transmit a stochastic control system enable system to an electric utility providing the AC indicating that AC provided the load(s) in a consumer premises is stochastically controlled, e.g., as described elsewhere herein, in the consumer premises. After blocks 225, 226, or 227 and when the first time period ends, return to block 221.

The processing circuitry described herein may optionally include at least one processor circuitry communicatively coupled to at least one memory circuitry. The processor circuitry described herein may include one or more microprocessors, microcontrollers, digital signal processing (DSP) elements, application-specific integrated circuits (ASICs), and/or field programmable gate arrays (FPGAs). In this exemplary embodiment, processor circuitry includes or functions with software programs, firmware, or other computer readable instructions for carrying out various process tasks, calculations, and control functions, used in the methods described herein. These instructions are typically tangibly embodied on any storage media (or computer readable medium) used for storage of computer readable instructions or data structures.

The memory circuitry described herein can be implemented with any available storage media (or computer readable medium) that can be accessed by a general purpose or special purpose computer or processor, or any programmable logic device. Suitable computer readable medium may include storage or memory media such as semiconductor, magnetic, and/or optical media. For example, computer readable media may include conventional hard disks, Compact Disk-Read Only Memory (CD-ROM), DVDs, volatile or non-volatile media such as Random Access Memory (RAM) (including, but not limited to, Dynamic Random Access Memory (DRAM)), Read Only Memory (ROM), Electrically Erasable Programmable ROM (EEPROM), and/or flash memory. Combinations of the above are also included within the scope of computer readable media.

Methods of the invention can be implemented in computer readable instructions, such as program modules or applications, which may be stored in the computer readable medium that is part of (optionally the memory circuitry) or communicatively coupled to the processing circuitry, and executed by the processing circuitry, optionally the processor circuitry. Generally, program modules or applications include routines, programs, objects, data components, data structures, algorithms, and the like, which perform particular tasks or implement particular abstract data types.

### Exemplary Embodiments

Example 1 includes a method for stochastically determining whether to reduce alternating current (AC) provided to a load, comprising: receiving a frequency of the AC; receiving or generating a random number; determining a probability threshold or a function of the probability threshold, wherein the probability threshold is a function of a difference between the frequency of the AC and a nominal frequency rating of an AC electrical power grid configured to provide AC to the load; determining whether (a) the frequency of the AC is less than the nominal frequency rating and (b) the random number is less than respectively the probability threshold or the function of the probability threshold; and determining that (a) the frequency of the AC is less than the nominal frequency rating and (b) the random number is less than respectively the probability threshold or the function of the probability threshold, then transmitting an AC reduction signal configured to cause the AC drawn by the load to be reduced for a first time period.

Example 2 includes the method of Example 1, further comprising causing the AC drawn by the load to be reduced.

Example 3 includes the method of any of Examples 1-2, wherein the probability threshold equals: α=k*|ω−ωo|, wherein k is a parameter with a scalar value greater than zero and which is constant or is a function of one or more other parameters, ω is the frequency of the AC, and ωo is the nominal frequency rating.

Example 4 includes the method of an of Examples 1-3, wherein the probability threshold or the function of the probability threshold is also a function of at least one of: at least one temperature and a number of times that the method caused a reduction of AC, at the load, during a second time period which is greater than the first time period.

Example 5 includes the method of any of Examples 1-4, further comprising transmitting a stochastic control system enable signal indicating that the AC powering the load is stochastically controlled in a consumer premises in which the load is located.

Example 6 includes the method of any of Examples 1-5, further comprises measuring the frequency of the AC in consumer premises where the load is located.

Example 7 includes a non-transitory computer readable medium storing a program causing at least one processor to execute a process to stochastically determine whether to reduce alternating current (AC) provided to a load, the process comprising: receiving a frequency of the AC; receiving or generating a random number; determining a probability threshold or a function of the probability threshold, wherein the probability threshold is a function of a difference between the frequency of the AC and a nominal frequency rating of an AC electrical power grid configured to provide AC to the load; determining whether (a) the frequency of the AC is less than the nominal frequency rating and (b) the random number is less than respectively the probability threshold or the function of the probability threshold; and determining that (a) the frequency of the AC is less than the nominal frequency rating and (b) the random number is less than respectively the probability threshold or the function of the probability threshold, then transmitting an AC reduction signal configured to cause the AC drawn by the load to be reduced for a first time period.

Example 8 includes the non-transitory computer readable medium of Example 7, wherein the process further comprises causing the AC drawn by the load to be reduced.

Example 9 includes the non-transitory computer readable medium of any of Examples 7-8, wherein the probability threshold equals: α=k ω−∫ₒ|, wherein k is a parameter with a scalar value greater than zero and which is constant or is a function of one or more other parameters, ω is the frequency of the AC, and wo is the nominal frequency rating.

Example 10 includes the non-transitory computer readable medium of any of Examples 7-9, wherein the probability threshold or the function of the probability threshold is also a function of at least one of: at least one temperature and a number of times that the process caused a reduction of AC, at the load, during a second time period which is greater than the first time period.

Example 11 includes the non-transitory computer readable medium of any of Examples 7-10, wherein the process further comprises causing transmission of a stochastic control system enable signal indicating that the AC powering the load is stochastically controlled in a consumer premises in which the load is located.

Example 12 includes the non-transitory computer readable medium of any of Examples 7-11, wherein receiving the frequency of the AC comprises receiving the frequency of the AC measured in consumer premises where the load is located.

Example 13 includes an apparatus which stochastically determines whether to reduce alternating current (AC) provided to a load, the apparatus comprising: communications circuitry configured to receive a frequency of the AC; and processing circuitry, communicatively coupled to the communications circuitry, and configured to perform a process comprising: receiving the frequency of the AC; receiving or generating a random number; determining a probability threshold or a function of the probability threshold, wherein the probability threshold is a function of a difference between the frequency of the AC and a nominal frequency rating of an AC electrical power grid configured to provide the AC to the load; determining whether (a) the frequency of the AC is less than the nominal frequency rating and (b) the random number is less than respectively the probability threshold or the function of the probability threshold; and determining that (a) the frequency of the AC is less than the nominal frequency rating and (b) the random number is less than respectively the probability threshold or the function of the probability threshold, then causing the communications circuitry to transmit an AC reduction signal configured to cause the AC drawn by the load to be reduced for a first time period.

Example 14 includes the apparatus of any of Example 13, wherein the process further comprises causing the AC drawn by the load to be reduced.

Example 15 includes the apparatus of any of Examples 13-14, wherein the probability threshold equals: α=k*|ω−ωₒ|, wherein k is a parameter with a scalar value greater than zero and which is constant or is a function of one or more other parameters, ω is the frequency of the AC, and ωₒ is the nominal frequency rating.

Example 16 includes the apparatus of any of Examples 13-15, wherein the probability threshold or the function of the probability threshold is also a function of at least one of: at least one temperature and a number of times that the process caused a reduction of AC, at the load, during a second time period which is greater than the first time period.

Example 17 includes the apparatus of any of Examples 13-16, wherein the processing circuitry is further configured to cause the communications circuitry to transmit a stochastic control system enable signal indicating that the AC powering the load is stochastically controlled in a consumer premises in which the load is located.

Example 18 includes the apparatus of any of Examples 13-17, further comprising a frequency detector configured to measure the frequency of the AC in consumer premises where the load is located; wherein the frequency detector is communicatively coupled to the communications circuitry.

Example 19 includes the apparatus of any of Examples 13-18, further comprising a power switch configured to reduce the AC provided to the load upon receipt of the AC reduction signal; wherein the power switch is communicatively coupled to the communications circuitry and is configured to provide the AC to the load.

Example 20 includes the apparatus of any of Examples 13-19, wherein the apparatus is co-packaged with the load.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A method for stochastically determining whether to reduce alternating current (AC) provided to a load, comprising:
receiving a frequency of the AC;
receiving or generating a random number;
determining a probability threshold or a function of the probability threshold, wherein the probability threshold is a function of a difference between the frequency of the AC and a nominal frequency rating of an AC electrical power grid configured to provide AC to the load;
determining whether (a) the frequency of the AC is less than the nominal frequency rating and (b) the random number is less than respectively the probability threshold or the function of the probability threshold; and
determining that (a) the frequency of the AC is less than the nominal frequency rating and (b) the random number is less than respectively the probability threshold or the function of the probability threshold, then transmitting an AC reduction signal configured to cause the AC drawn by the load to be reduced for a first time period.

2. The method of claim 1, further comprising causing the AC drawn by the load to be reduced.

3. The method of claim 1, wherein the probability threshold equals:
$$α = k * \vert ω - {ω}_{o} \vert ,$$
wherein k is a parameter with a scalar value greater than zero and which is constant or is a function of one or more other parameters, ω is the frequency of the AC, and ω₀ is the nominal frequency rating.

4. The method of claim 1, wherein the probability threshold or the function of the probability threshold is also a function of at least one of: at least one temperature and a number of times that the method caused a reduction of AC, at the load, during a second time period which is greater than the first time period.

5. The method of claim 1, further comprising transmitting a stochastic control system enable signal indicating that the AC powering the load is stochastically controlled in a consumer premises in which the load is located.

6. The method of claim 1, further comprises measuring the frequency of the AC in consumer premises where the load is located.

7. A non-transitory computer readable medium storing a program causing at least one processor to execute a process to stochastically determine whether to reduce alternating current (AC) provided to a load, the process comprising:
receiving a frequency of the AC;
receiving or generating a random number;
determining a probability threshold or a function of the probability threshold, wherein the probability threshold is a function of a difference between the frequency of the AC and a nominal frequency rating of an AC electrical power grid configured to provide AC to the load;
determining whether (a) the frequency of the AC is less than the nominal frequency rating and (b) the random number is less than respectively the probability threshold or the function of the probability threshold; and
determining that (a) the frequency of the AC is less than the nominal frequency rating and (b) the random number is less than respectively the probability threshold or the function of the probability threshold, then transmitting an AC reduction signal configured to cause the AC drawn by the load to be reduced for a first time period.

8. The non-transitory computer readable medium of claim 7, wherein the process further comprises causing the AC drawn by the load to be reduced.

9. The non-transitory computer readable medium of claim 7, wherein the probability threshold equals:
$$α = k * \vert ω - {ω}_{o} \vert ,$$
wherein k is a parameter with a scalar value greater than zero and which is constant or is a function of one or more other parameters, ω is the frequency of the AC, and ω₀ is the nominal frequency rating.

10. The non-transitory computer readable medium of claim 7, wherein the probability threshold or the function of the probability threshold is also a function of at least one of: at least one temperature and a number of times that the process caused a reduction of AC, at the load, during a second time period which is greater than the first time period.

11. The non-transitory computer readable medium of claim 7, wherein the process further comprises causing transmission of a stochastic control system enable signal indicating that the AC powering the load is stochastically controlled in a consumer premises in which the load is located.

12. The non-transitory computer readable medium of claim 7, wherein receiving the frequency of the AC comprises receiving the frequency of the AC measured in consumer premises where the load is located.

13. An apparatus which stochastically determines whether to reduce alternating current (AC) provided to a load, the apparatus comprising:
communications circuitry configured to receive a frequency of the AC; and
processing circuitry, communicatively coupled to the communications circuitry, and configured to perform a process comprising:
receiving the frequency of the AC;
receiving or generating a random number;
determining a probability threshold or a function of the probability threshold, wherein the probability threshold is a function of a difference between the frequency of the AC and a nominal frequency rating of an AC electrical power grid configured to provide the AC to the load;
determining whether (a) the frequency of the AC is less than the nominal frequency rating and (b) the random number is less than respectively the probability threshold or the function of the probability threshold; and
determining that (a) the frequency of the AC is less than the nominal frequency rating and (b) the random number is less than respectively the probability threshold or the function of the probability threshold, then causing the communications circuitry to transmit an AC reduction signal configured to cause the AC drawn by the load to be reduced for a first time period.

14. The apparatus of claim 13, wherein the process further comprises causing the AC drawn by the load to be reduced.

15. The apparatus of claim 13, wherein the probability threshold equals:
$$α = k * \vert ω - {ω}_{o} \vert ,$$
wherein k is a parameter with a scalar value greater than zero and which is constant or is a function of one or more other parameters, ω is the frequency of the AC, and ω₀ is the nominal frequency rating.

16. The apparatus of claim 13, wherein the probability threshold or the function of the probability threshold is also a function of at least one of: at least one temperature and a number of times that the process caused a reduction of AC, at the load, during a second time period which is greater than the first time period.

17. The apparatus of claim 13, wherein the processing circuitry is further configured to cause the communications circuitry to transmit a stochastic control system enable signal indicating that the AC powering the load is stochastically controlled in a consumer premises in which the load is located.

18. The apparatus of claim 13, further comprising a frequency detector configured to measure the frequency of the AC in consumer premises where the load is located;
wherein the frequency detector is communicatively coupled to the communications circuitry.

19. The apparatus of claim 13, further comprising a power switch configured to reduce the AC provided to the load upon receipt of the AC reduction signal;
wherein the power switch is communicatively coupled to the communications circuitry and is configured to provide the AC to the load.

20. The apparatus of claim 13, wherein the apparatus is co-packaged with the load.
